(19) United States
(12) Patent Application Publication
(10) Pub. No.: US 2009/0287715 A1
(43) Pub. Date: Nov. 19, 2009

(54) FILE SHARING METHOD AND FILE SHARING SYSTEM FOR GETTING AN ACCESSIBLE ADDRESS THROUGH AN ADDRESS MAPPING SERVER

(76) Inventors: Wei-Hsiang Chi, Taipei City (TW); Shih-Hua Yu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/431,772

(22) Filed: Apr. 29, 2009

(30) Foreign Application Priority Data
May 19, 2008 (TW) 097118380

(51) Int. Cl. G06F 17/30

(52) U.S. Cl. 707/10; 707/E17.01; 707/E17.032

(57) ABSTRACT

A file sharing method includes: transferring content information related to a to-be-shared file to an address mapping server; and the address mapping server providing an accessible address mapped to the to-be-shared file according to the content information. One advantage of using the above file sharing method is that the user who wants to share files does not need to apply network space and upload the files beforehand.

### BACKGROUND OF THE INVENTION

1. Field of the Invention

The invention relates to a file sharing mechanism and, more particularly, to a file sharing system for getting an accessible address through an address mapping server and the method thereof.

2. Description of the Prior Art

Generally speaking, there are many methods of sharing files from remote terminals through network, such as through file transfer protocol (FTP), peer-to-peer (P2P), My Network Places in Microsoft operating system, or E-mail. With the development of the World Wide Web, more and more network operations are carried out through web browser, including blog and webmail. Remote file access is also one of them.

Traditionally, there are several methods of accessing remote files. The conventional method is uploading “the to-be-shared files” to a network space. User can download the files by selecting through an interface provided by the web page. However, to use this method, first, user need to apply for a network space and perform an uploading procedure.

Another conventional method is transferring files by E-mail However, to use this method; user needs to open the E-mail software and wastes a hard disk space repeatedly.

### SUMMARY OF THE INVENTION

An objective of the invention is to provide a file sharing method and file sharing system utilizing an address mapping server.

The invention is to provide a file sharing method. The method includes: transferring a content information related to a “to-be-shared file” to an address mapping server; and the address mapping server providing a accessible address mapped to the to-be-shared file according to the content information.

Furthermore, the invention also provides a file sharing system. The file sharing system includes a first user terminal and an address mapping server. The first user terminal includes a storage device for storing a to-be-shared file and a controller for outputting content information related to the to-be-shared file. The address mapping server is coupled to the first user terminal and used for providing an accessible address mapped to the to-be-shared file according to the content information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram showing a file sharing system according to one embodiment of the invention.

FIG. 2 is a flow chart showing the operation of the file sharing system of FIG. 1.

### DETAILED DESCRIPTION

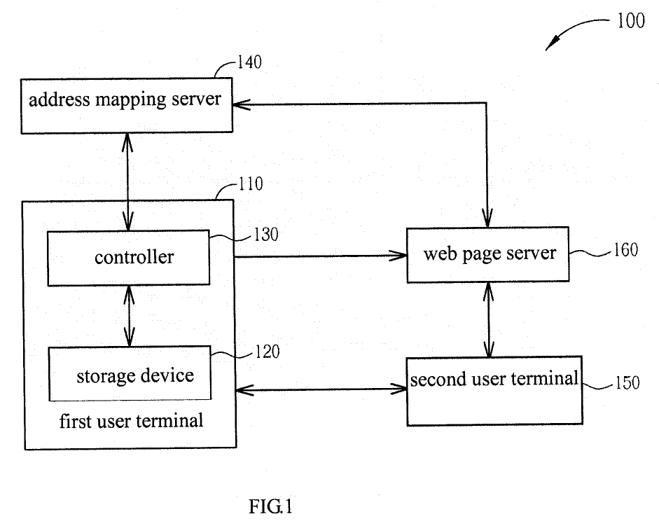

FIG. 1 is a functional block diagram showing a file sharing system 100 according to one embodiment of the invention. The file sharing system 1 00 includes a first user terminal 110, an address mapping server 140, a second user terminal 150, and a web server 160. Furthermore, the first user terminal 110 includes a storage device 120 and a controller 130. In the embodiment, the first user terminal 110 is a file provider, and the second user terminal 150 is a file accessor. The first user terminal 110, stored the to-be-shared file in the storage device 120, and the controller 130 is used for outputting content information related to the to-be-shared file (directory structures, file names, storing position, etc.).

Notablely, the to-be-shared file can include a single file, a single directory, or a directory tree. That is, the present embodiment of the file sharing mechanism is not limited by the size or category of the to-be-shared file.

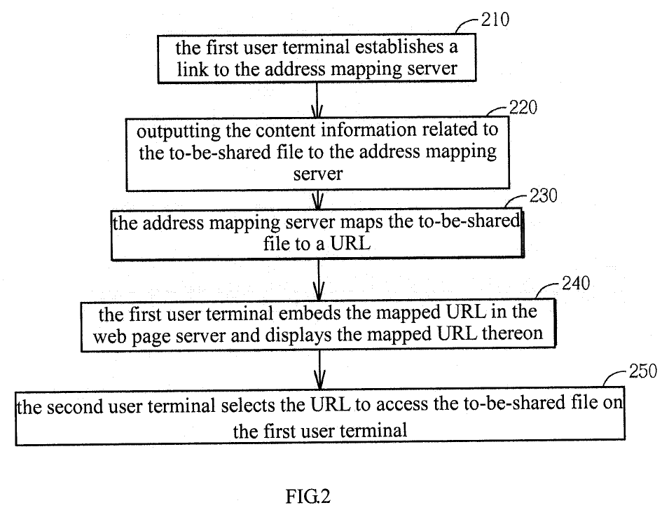

FIG. 2 is a flow chart showing the operation of the file sharing system 100 of FIG. 1. (Note: should be consistent with the Brief Description of the Drawings.) Without affecting the disclosure of the invention, the flow shown in FIG. 2 only includes the steps relevant to the invention. The operation of the file sharing mechanism according to the embodiment of the invention can be summarized as follows:

Step 210: the first user terminal 110 establishes a link to the address mapping server 140 through the controller 130.

Step 220: the content information related to the to-be-shared file is output to the address mapping server 140.

Step 230: according to the content information related to the first user terminal 110, the address mapping server 140 maps the to-be-shared file of the first user terminal 110 to an accessible address, such as a Uniform Resource Locator (URL), and transfers the URL back to the first user terminal 110.

Step 240: the first user terminal 110 embeds the mapped URL in a web page and display the mapped URL on the web server 160.

Step 250: after selecting the URL through the web page provided by the web server 160, the second user terminal 150 is directly linked to the first user terminal 110 and accessed the to-be-shared file on the first user terminal 110.

Please refer to both FIG. 1 and FIG. 2. Detailed description of the implement of the file sharing mechanism is as follows. First, the user must provide the to-be-shared file (such as a video file) in the first user terminal 110 (such as a personal computer). Next, after the to-be-shared video file is selected, an application programming interface (API) provided by the controller 130 actively establishes a link with the address mapping server 140 to inform the address mapping server 140 of content information related to the to-be-shared video file (such as the network address of the first user terminal 110, the name and size of the to-be-shared file, or the structure of the directory tree).

In the embodiment, the address mapping server 140 provides that the to-be-shared video file is mapped to an URL according to the file content information provided by the API. After that, the address mapping server 140 sends the URL back to the API of the first user terminal 110 for subsequent file sharing. Therefore, with the assistance of the address mapping sever 140, the user can obtain the URL of the to-be-shared video file easily. In the embodiment, the user can embed a URL provided by the address mapping server 140 in a web page provided by the web server 160 for sharing the URL by any known way. That is, other users can know the URL by reading the web page provided by the web server 160. For example, the user of the first user terminal 110 informs the user of the second user terminal 150 that there is link content information (that is, a URL) related to the to-be-shared video file on the web page of the web server 160. After that, when browsing the web page which the URL is embedded in, the user of the second user terminal 150 can select the corresponding link on the web page. Then, a direct link between the first user terminal 110 and the second user terminal 150 without other intermediate devices can be established through the URL provided by the address mapping server 140. Finally, after being linked to the first user terminal 110 successfully, the second user terminal 150 can read the to-be-shared video file stored in the storage device 120 of the first user terminal 110 through file transferring mechanisms (such as FTP or other transfer protocols).

As shown in FIG. 1, in the embodiment, the web server 160 can inquire mapping address from the address mapping server 140 directly, and obtain the content information (such as network address of the user terminal providing the to-be-shared file/directory or the name of the to-be-shared file/directory) related to the to-be-shared file/directory to which the URL provided by the address mapping server 140 is mapped. However, this is only for exemplary purpose without limiting sense. Any modification or variation without departing from the spirit of the invention is within the scope of the invention.

Notablely, in the above embodiment, the user of the first user terminal 110 embeds the mapped URL of the to-be-shared file into the web page such that the other users can read the to-be-shared file conveniently.

However, this does not limit the invention and (since) other methods publishing the URL provided by the address mapping server 140 are also workable. For example, in other embodiments of the invention, after receiving the mapped URL content information provide by the address mapping server 140, the user of the first user terminal 110 can send the URL to the second user terminal 150 through E-mail. Next, the second user terminal 150 can select the URL taken in the E-mail to establish a link between the first user terminal 110 and the second user terminal 150 and to read the to-be-shared file in the first user terminal 110.

From above, for file sharing, compared with the first conventional file sharing method, the file sharing mechanism according to the embodiment of the invention does not need to apply for network space and upload files beforehand. On the other hand, compared with the second conventional file sharing method, the file sharing mechanism according to the embodiment of the invention does not waste the procedure and the disk space needed by E-mail.

The above are just preferred embodiments of the invention, various modifications and changes according to the appended claims of the invention belongs to the scope of the invention.

Those skilled in the art will readily observe that numerous modifications and alterations of the device and method may be made while retaining the teachings of the invention.

What is claimed is:

1. A file sharing method, comprising the following steps of:
transferring content information related to a to-be-shared file to an address mapping server; and
providing, by the address mapping server, an accessible address mapped to the to-be-shared file according to the content information.

2. The method according to claim 1, further comprising the step of accessing the to-be-shared file directly according to the accessible address.

3. The method according to claim 1, further comprising the step of embedding the accessible address into a web page.

4. The method according to claim 2, wherein the step of accessing the to-be-shared file directly according to the accessible address comprises clicking the accessible address embedded in the web page to access the to-be-shared file directly.

5. The method according to claim 1, wherein the accessible address conforms to the format of Uniform Resource Locator (URL).

6. A file sharing system, comprising:
a first user terminal, including:
a storage device for storing a to-be-shared file;
a controller for outputting a content information related to the to-be-shared file to a address mapping server; and
an address mapping server, coupled to the first user terminal, for providing an accessible address mapped to the to-be-shared file according to the content information.

7. The file sharing system according to claim 6, further comprising:
a second user terminal accessed the to-be-shared file from the storage device of the first user terminal directly, according to the accessible address.

8. The file sharing system according to claim 6, further comprising:
a web server used for providing a web page, wherein the accessible address is embedded in the web page.

9. The file sharing system according to claim 7, wherein the second user terminal selects the accessible address embedded in the web page to access the to-be-shared file directly.

10. The file sharing system according to claim 6, wherein the accessible address conforms to the format of Uniform Resource Locator.
